(19) United States
(12) Patent Application Publication
(10) Pub. No.: US 2024/0424819 A1
(43) Pub. Date: Dec. 26, 2024

(54) Recording Method

(71) Applicant: SEIKO EPSON CORPORATION, Tokyo (JP)

(72) Inventors: Takayoshi KAGATA, Shiojiri (JP); Masakazu OHASHI, Shiojiri (JP)

(21) Appl. No.: 18/613,473

(22) Filed: Mar. 22, 2024

(30) Foreign Application Priority Data
Mar. 24, 2023 (JP) 2023-047860

(51) Int. Cl. B41M 5/025; B41M 3/00; B41M 5/035; C09D 11/033; C09D 11/104; C09D 11/106; C09D 11/34; C09D 11/54; D06P 1/52; D06P 5/00; D06P 5/24; D06P 5/30

(52) U.S. Cl. CPC B41M 5/0256; B41M 3/008; B41M 5/0356; C09D 11/033; C09D 11/104; C09D 11/106; C09D 11/34; C09D 11/54; D06P 1/5235; D06P 1/5271; D06P 1/5285; D06P 5/002; D06P 5/009; D06P 5/30; B41M 2205/06; B41M 2205/10; B41M 2205/42

(57) ABSTRACT

A recording method according to the present disclosure includes: ejecting a pigment ink containing a pigment and water from an ink jet head onto a transfer medium having a release layer to form a first layer; ejecting a processing solution from the ink jet head onto the first layer to form a second layer; and heating a surface of the transfer medium that has the first layer and the second layer, with the surface facing an absorbent receiving medium, to thermally transfer the first layer and the second layer onto the receiving medium, wherein the pigment ink contains a resin in an amount of 15.0 mass % or less, the processing solution contains a resin and water, and the first layer has a dryness of 0% or more and 80% or less when the processing solution is ejected.

The present application is based on, and claims priority from JP Application Serial Number 2023-047860, filed Mar. 24, 2023, the disclosure of which is hereby incorporated by reference herein in its entirety.

### BACKGROUND

### 1. Technical Field

The present disclosure relates to a recording method.

### 2. Related Art

A known transfer printing method involves overlying a transfer sheet, which is a transfer medium having an image thereon, on a receiving medium, such as fabric and applying heat and pressure to the transfer sheet to transfer the image to the receiving medium. In such a method, the image on the transfer sheet is usually formed using ink jet technology, which can advantageously form fine images with high on-demand capability. When the receiving medium is an absorbent medium, such as fabric and leather, washing fastness is also required.

In the above-described transfer printing, an image is formed on a transfer sheet that has a release layer and a hot melt layer on the entire surface of the base, and then the transfer sheet is heated and pressurized to transfer the image on the receiving medium.

However, in the recorded product produced using such a method, the hot melt layer is transferred to the receiving medium together with the image and thus is present in an area of the receiving medium outside the image, impairing the texture of the receiving medium. In particular, when the recorded product is clothing, the wearer is likely to feel discomfort.

To solve the above problem, JP-A-2019-171840 proposes a method of transferring an image on a transfer sheet to a receiving object. The method includes, in sequence, forming an image on a surface of the transfer sheet by using an ink containing a pigment, sprinkling a heat-melting powder on the surface of the transfer sheet so that the powder adheres to the entire surface of the ink without gaps, removing the powder from the area having no image, overlaying the transfer sheet onto a receiving object, which is a receiving medium, and applying heat and pressure to the area having the image at the powder melting temperature.

The above-described method provides a slight improvement over the method that uses a transfer sheet having a hot-melt layer over the entire surface, but still does not provide satisfactory texture. Furthermore, this method requires a space for manual powder sprinkling operation or an installation space for a machine that sprinkles powder, in addition to the space for an image forming apparatus that forms an image on the transfer sheet by using the ink jet technology and a transfer machine that transfers the image by application of heat and pressure, increasing a space for production of recorded products. Furthermore, this method requires a step of shaking off or suctioning off the powder that was sprinkled on the transfer sheet but not adhered to the image, making it difficult to improve the productivity of the recorded products.

### SUMMARY

The present disclosure was made to solve the above-described problems, and aspects of the present disclosure will be described below.

According to an aspect of the present disclosure, a recording method includes: a first layer forming step of ejecting a pigment ink containing a pigment and water from an ink jet head onto a transfer medium having a release layer to form a first layer; a second layer forming step of ejecting a processing solution from the ink jet head onto the first layer to form a second layer; and a thermal transfer step of heating a surface of the transfer medium that has the first layer and the second layer, with the surface facing an absorbent receiving medium, to thermally transfer the first layer and the second layer onto the receiving medium, wherein the pigment ink contains a resin in an amount of 15.0 mass % or less, the processing solution contains a resin and water, and the first layer has a dryness of 0% or more and 80% or less when the processing solution is ejected.

A recording method according to another aspect of the present disclosure includes: a first layer forming step of ejecting a pigment ink that contains a pigment, a resin having a glass transition temperature of −40° C. or more and 0° C. or less, an organic solvent having a boiling point of 280° C. or more, and water from an ink jet head onto a transfer medium having a release layer to form a first layer; a second layer forming step of ejecting a processing solution from the ink jet head onto the first layer to form a second layer; and a thermal transfer step of heating a surface of the transfer medium that has the first layer and the second layer, with the surface facing an absorbent receiving medium formed of fabric or leather, to thermally transfer the first layer and the second layer onto the receiving medium, wherein the pigment ink contains the resin in an amount of 2.0 mass % or more and 15.0 mass % or less, the processing solution contains a resin having a glass transition temperature of −20° C. or more and 50° C. or less and a melting point of 80° C. or more and 140° C. or less and water and is free from organic solvents having a boiling point of 280° C. or more, the resin contained in the processing solution is at least one selected from the group consisting of polyester, polyurethane, and polyvinyl chloride, the processing solution contains the resin in an amount of 5.0 mass % or more and 20.0 mass % or less, and the first layer has a dryness of 0% or more and 80% or less when the processing solution is ejected.

### BRIEF DESCRIPTION OF THE DRAWINGS

FIGS. 1A to 1D illustrate steps of a recording method according to a preferred embodiment of the present disclosure.

FIG. 2 is a table indicating compositions of pigment inks of Preparations A1 to A5.

FIG. 3 is a table indicating compositions of processing solutions of Preparations B1 to B5.

FIG. 4 is a table collectively indicating conditions of the recording methods in Examples 1 to 12.

FIG. 5 is a table collectively indicating conditions of the recording methods in Examples 13 to 19 Comparative Examples 1 to 4.

FIG. 6 is a table collectively indicating evaluations of Examples 1 to 12.

FIG. 7 is a table collectively indicating evaluations of Examples 13 to 19 and Comparative Examples 1 to 4.

### DESCRIPTION OF EMBODIMENTS

Hereinafter, a preferred embodiment of the present disclosure will be described in detail.

### 1. Recording Method

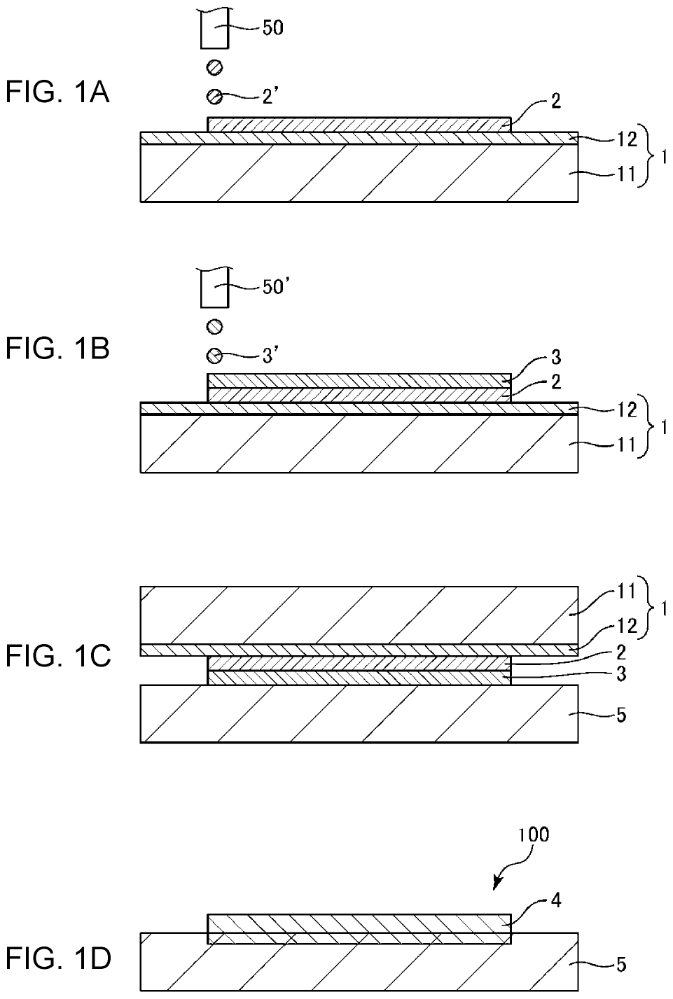

First, a recording method according to the present disclosure will be described. FIGS. 1A to 1D illustrate steps of a recording method according to a preferred embodiment of the present disclosure.

The recording method according to the present disclosure includes: a first layer forming step (1A) of ejecting a pigment ink 2′ containing a pigment and water from an ink jet head 50 onto a transfer medium 1 having a release layer 12 to form a first layer 2; a second layer forming step (1B) of ejecting a processing solution 3′ from the ink jet head 50′ onto the first layer 2 to form a second layer 3; and a thermal transfer step (1C) of heating the surface of the transfer medium 1 that has the first and second layers 2 and 3, with the surface facing an absorbent receiving medium 5, to thermally transfer the first and second layers 2 and 3 to the receiving medium 5. In the above method, the pigment ink 2′ contains a resin in an amount of 15.0 mass % or less, the processing solution 3′ contains a resin and water, and the first layer 2 has a dryness of 0% or more and 80% or less when the processing solution 3′ is ejected.

This configuration can provide a recording method that can stably produce, by using the ink jet technology, recorded products 100 having excellent texture, high chromogenic properties at the recording section 4, and high washing fastness, and can prevent an increase in size of the apparatus. Furthermore, the use of the pigment ink 2′ containing water and a pigment enables employment of a common compact and inexpensive home ink jet recording apparatus that uses water-based pigment inks. This advantageously simplifies the recording method and reduce the cost.

The above effects are achieved for the following reasons. In short, the recording method according to the present disclosure does not require sprinkling of powder and removal of excess powder, enabling the production of recorded products in a small space with high productivity. Furthermore, the use of pigments enables production of the recording section having high chromogenic properties. In the present disclosure, a processing solution containing a resin and water is applied onto the first layer to form the second layer on the first layer before the first layer containing a pigment ink dries too much. This allows the recording section on the receiving medium to have the moderately mixed pigment and resin, and a portion of the mixture containing the pigment and resin readily penetrates into the absorbent receiving medium when transferred onto the receiving medium. Thus, the recording section after transfer has high adhesion to the receiving medium and high washing fastness, and also the produced recorded products have excellent texture. Furthermore, the resin content in the pigment ink is less than or equal to a predetermined value. This enables stable ejection using the ink jet technology and reduces nozzle clogging of the ink jet head, reducing the maintenance to unclog the nozzle, enabling stable production of high-quality recorded products, and thus increasing the productivity of excellent recorded product. If the ink jet head has nozzle clogging, the nozzle can be properly unclogged by cleaning or the like.

In contrast, when the above conditions are not satisfied, satisfactory results cannot be obtained. For example, if dyes are used instead of pigments, the chromogenic properties at the recording section cannot be sufficiently high.

If a powder composed of a hot melt resin is used in place of the processing solution, the size of the apparatus that produces the recorded products increases, and the space required to produce the recorded products increases, and thus the productivity of the recorded products decreases. Furthermore, this does not allow the produced recorded products to have sufficiently good texture. In this specification, hot melt resins refer to resins having a melting point of 100° C. or more and 160° C. or less and a glass transition temperature of 0° C. or more and 50° C. or less.

If the resin content in the pigment ink is too large, the ejection stability of the pigment ink by the ink jet technology will decrease. This makes it difficult to stably produce recorded products. Furthermore, this deteriorates the texture of the produced recorded product.

If the dryness of the first layer is too high when the processing solution is ejected, the recording section cannot be sufficiently adhered to the receiving medium, and thus the recorded product has poor washing fastness.

In the present disclosure, the absorbent receiving medium refers to a receiving medium that absorbs more than 10 mL/m² of water for the period from the first contact to 30 msec^{1/2} in accordance with the Bristow method. The Bristow method is the most widely used method for measuring the amount of liquid absorbed in a short period of time and has been adopted by Japan Technical Association of the Pulp and Paper Industry (JAPAN TAPPI). The test method is detailed in Specification No. 51 “Kami Oyobi Itagami-Ekitai Kyushusei Siken Houhou-Buristo Hou (Paper and Cardboards-Liquid Absorption Test Methods-Bristow Method) in “JAPAN TAPPI Kami Parupu Shiken Hoho 2000” (JAPAN TAPPI Pulp and Paper Test Methods 2000).

In the present disclosure, the dryness of the first layer refers to the percentage of the components that has been removed by being dried from the total liquid components of the pigment ink forming the first layer. The dryness can be determined by measuring the mass of the transfer medium having the pigment ink.

### 1-1 First Layer Forming Step

In the first layer forming step, the pigment ink 2′ containing a pigment and water is ejected from the ink jet head 50 onto the transfer medium 1 having the release layer 12 to form the first layer 2 (1a).

### 1-1-1 Transfer Medium

The transfer medium 1 may be any medium that has the release layer 12. In this embodiment, the transfer medium 1 has a base 11 and the release layer 12. Thus, the transfer medium 1 has higher handling properties.

The transfer medium 1 may have any shape, preferably a sheet-like shape. This makes formation of the first layer 2 and the second layer 3 by the ink jet technology easier.

The base 11 may be formed of, for example, paper, a plastic material, or a metal material.

Examples of the plastic material forming the base 11 include polyester such as polyethylene terephthalate, polyolefin such as polyethylene and polypropylene.

The base 11 may have any shape, preferably a sheet-like shape. When the base 11 has a sheet-like shape, the thickness of the base 11 may be preferably 50 μm or more and 200 μm or less.

The release layer 12 is a layer having mold removability. The release layer 12 of the transfer medium 1 properly prevents the constituents of the first layer 2 and the second layer 3 from unintentionally remaining on the transfer medium 1 after the thermal transfer step.

The release layer 12 may be formed of, for example, a polyethylene wax release agent, a silicone release agent, or a fluorine release agent.

The release layer 12 may have any thickness. However, the thickness may be preferably 5 μm or more and 80 μm or less, more preferably 10 μm or more and 50 μm or less.

### 1-1-2 Pigment Ink

The pigment ink 2′ contains a pigment and water. The pigment ink 2′ contains a resin in an amount of 15.0 mass % or less.

As above, the resin content in the pigment ink 2′ is sufficiently low. This allows the ejection stability of the pigment ink 2′ by the ink jet technology to be high and thus allows stable production of the recorded products 100. This also allows the produced recorded products 100 to have excellent texture.

### 1-1-2-1 Pigment

Examples of the pigment contained in the pigment ink 2′ include inorganic pigments and organic pigments. The pigment may contain two or more components in combination.

Examples of the inorganic pigment include carbon blacks such as furnace black, lamp black, acetylene black, and channel black, iron oxide, and titanium dioxide.

Examples of the organic pigment include azo pigments, such as insoluble azo pigments, condensed azo pigments, azo lakes, and chelate azo pigments, polycyclic pigments, such as phthalocyanine pigments, perylene pigments, perinone pigments, anthraquinone pigments, quinacridone pigments, dioxane pigments, thioindigo pigments, isoindolinone pigments, and quinophthalone pigments, dye chelates, such as basic-dye chelates and acid-dye chelates, dye lakes, such as basic-dye lakes and acidic-dye lakes, nitro pigments, nitroso pigments, and aniline black, daylight fluorescent pigments.

More specifically, examples of carbon black used as black pigments include No. 2300, No. 900, MCF88, No. 33, No. 40, No. 45, No. 52, MA7, MA8, MA100, No. 2200B (available from Mitsubishi Chemical Corporation), Raven 5750, Raven 5250, Raven 5000, Raven 3500, Raven 1255, Raven 700 (available from Columbian Carbon Company), Regal 400R, Regal 330R, Regal 660R, Mogul L, Monarch 700, Monarch 800, Monarch 880, Monarch 900, Monarch 1000, Monarch 1100, Monarch 1300, Monarch 1400 (available from Cabot Corporation), Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (available from Degussa).

Examples of white pigments include C.I. Pigment White 6, 18, and 21.

Examples of yellow pigments include C. I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of red-violet pigments include C. I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1 88, 112, 114, 122, 123, 144, 146, 149, 150, 166, 168, 170, 171, 175, 176, 177, 178, 179, 184, 185, 187, 202, 209, 219, 224, and 245, and C.I. Pigment Violet 19, 23, 32, 33, 36, 38, 43, and 50.

Examples of indigo-purple pigments include C.I. Pigment Blue 1, 2, 3, 15, 15:1, 15:2, 15:3, 15:34, 15:4, 16, 18, 22, 25, 60, 65, and 66, and C.I. Vat Blue 4 and 60.

Examples of pigments other than the above include C. I. Pigment Green 7 and 10, C. I. Pigment Brown 3, 5, 25, and 26, and C. I. Pigment Orange 1, 2, 5, 7, 13, 14, 15, 16, 24, 34, 36, 38, 40, 43, and 63.

The pigment ink 2′ may contain a self-dispersing pigment as a pigment. The self-dispersing pigment has a hydrophilic group on its surface. Examples of the hydrophilic groups include —OM, —COOM, —CO—, —SO₃M, —SO₂M, —SO₂NH₂, —RSO₂M, —PO₃HM, —PO₃M₂, —SO₂NHCOR, —NH₃, and —NR₃. In the formula, M represents a hydrogen atom, an alkali metal, an ammonium, or an organic ammonium, and R represents an alkyl group having 1 to 12 carbon atoms or a naphthyl group that may have a substituent. A phenyl group, for example, may be present between the surface of the pigment and the hydrophilic group.

The self-dispersing pigment can be produced by subjecting the pigment to a physical treatment or a chemical treatment so that the surface of the pigment has a hydrophilic group. Examples of the physical treatment include a vacuum plasma treatment. Examples of the chemical treatment include a wet oxidation method in which oxidation using an oxidant is performed in water.

The self-dispersing pigment may be preferably a surface treated self-dispersing pigment that has been subjected to an oxidation treatment with a hypohalous acid and/or a hypohalite, an oxidation treatment with ozone, or an oxidation treatment with a persulfuric acid and/or a persulfate in order to have high color development. The self-dispersing pigment may be a commercially available product. Preferred examples thereof include Microjet CW1 (available from Orient Chemical Industries, Co., ltd.), CAB-O-JET250C, CAB-O-JET260M, CAB-O-JET270Y, and CAB-O-JET444MP (available from Cabot Corporation).

The pigment ink 2′ may contain a pigment in any amount. However, the pigment content is preferably 1.0 mass % or more and 25.0 mass % or less, more preferably 2.0 mass % or more and 20.0 mass % or less, and further more preferably 5.0 mass % or more and 15.0 mass % or less.

This readily allows the recording section 4 formed of the pigment ink 2′ to have a sufficient color density and thus improves the chromogenic properties of the receiving medium, and also improves the storage stability of the pigment ink 2′, the ejection stability of the ink jet technology, and the recoverability from clogging in the ink jet head.

### 1-1-2-2 Water

The pigment ink 2′ contains water. Water functions as a dispersant that disperses the pigments in the pigment ink 2′.

The pigment ink 2′ may contain water in an amount of preferably 50.0 mass % or more and 75.0 mass % or less, more preferably 52.0 mass % or more and 70.0 mass % or less, and further more preferably 54.0 mass % or more and 65.0 mass % or less.

### 1-1-2-3 Organic Solvent

The pigment ink 2′ may contain an organic solvent.

This enables proper adjustment of the viscosity and surface tension of the pigment ink 2′. Furthermore, this, for example, improves the moisture retention of the pigment ink 2′, and thus effectively prevents unintentional precipitation of solids from the pigment ink 2′ due to drying in the ink jet head, for example. This can also improve the recoverability from clogging, resulting in improvement of the ejection stability of the pigment ink 2′.

The organic solvent is preferably a water-soluble organic solvent. As the water-soluble organic solvent, an organic solvent having a solubility of 10 g/100 g water or more at 25° C. is preferably used.

In particular, the pigment ink 2′ may preferably contain an organic solvent having a boiling point of 280° C. or more.

This improves the moisture retention of the pigment ink 2′, allowing the dryness of the first layer 2 when the processing solution 3′ is ejected to readily satisfy the above conditions.

Examples of the organic solvent, especially the water-soluble organic solvent, contained in the pigment ink 2′ include polyol compounds, glycol ethers, and cyclic amide compounds. One or more of these may be used in combination.

Examples of the polyol compound include a polyol compound, preferably a diol compound, which has 2 to 6 carbon atoms in a molecule thereof and may have one ether bond in a molecule thereof. Specific examples thereof include 1,2-pentanediol, glycerin, ethylene glycol, diethylene glycol, triethylene glycol, polyethylene glycol, propylene glycol, dipropylene glycol, tripropylene glycol, polypropylene glycol, polyoxyethylene polyoxypropylene glycol, 1,2-hexanediol, 1,2-heptanediol, 1,3-propanediol, 1,2-butanediol, 1,3-butanediol, 1,4-butanediol, 2,3-butanediol, 2-methyl-3-phenoxy-1,2-propanediol, 3-(3-methylphenoxy)-1,2-propanediol, 3-hexyloxy-1,2-propanediol, 2-hydroxymethyl-2-phenoxymethyl-1,3-propanediol, 3-methyl-1,3-butanediol, 1,5-pentanediol, 1,6-hexanediol, 2-methyl-2,4-pentanediol, 3-methyl-1,5-pentanediol, and other glycols.

Examples of the glycol ether include monoalkyl ethers of glycol selected from the group consisting of ethylene glycol, diethylene glycol, triethylene glycol, polyethylene glycol, propylene glycol, dipropylene glycol, tripropylene glycol, polypropylene glycol, and polyoxyethylene polyoxypropylene glycol. Examples of the monoalkyl ethers include triethylene glycol mono methyl ether, triethylene glycol mono butyl ether, triethylene glycol monoethyl ether, and dipropylene glycol mono propyl ether.

Examples of the cyclic amide compounds include 2-pyrrolidone, N-methyl-2-pyrrolidone, N-hydroxyethyl-2-pyrrolidone, 1,3-dimethylimidazolidinone, 2-piperidone (δ-valerolactam), and N-cyclohexyl-2-pyrrolidone.

The pigment ink 2′ may contain an organic solvent in an amount of preferably 5.0 mass % or more and 35.0 mass % or less, more preferably 10.0 mass % or more and 30.0 mass % or less, and further more preferably 15.0 mass % or more and 25.0 mass % or less.

This enables more proper adjustment of the viscosity and surface tension of the pigment ink 2′. In addition, this improves the moisture retention of the pigment ink 2′, and thus effectively prevents unintentional precipitation of solids from the pigment ink 2′ due to drying in the ink jet head, for example. This can also improve the recoverability from clogging, resulting in improvement of the ejection stability of the pigment ink 2′. In addition, this allows the dryness of the first layer 2 when the processing solution 3′ is ejected to readily satisfy the above conditions.

### 1-1-2-4 Resin

The pigment ink 2′ may contain a resin.

This improves, for example, adhesion of the recording section 4 containing the pigment to the receiving medium 5. This also improves the dispersion stability of the pigment in the pigment ink 2′.

The resin content in the pigment ink 2′ should be 15.0 mass % or less.

This allows the ejection stability of the pigment ink 2′ by the ink jet technology to be sufficiently high and thus allows stable production of the recorded products 100. This also allows the produced recorded products 100 to have excellent texture.

The pigment ink 2′ is only required to contain the resin in an amount of 15.0 mass % or less and may be free from the resin. However, the resin content in the pigment ink 2′ may be preferably 2.0 mass % or more and 13.0 mass % or less, more preferably 4.0 mass % or more and 12.0 mass % or less, and further more preferably 7.0 mass % or more and 11.0 mass % or less.

This allows the ejection stability of the pigment ink 2′ by the ink jet technology, the production stability of the recorded products 100, and the texture of the recorded products 100 to be sufficiently high and also improves the dispersion stability of the pigment in the pigment ink 2′ and the adhesion of the recording section 4 to the receiving medium 5.

When the pigment ink 2′ contains a resin, the resin may be contained in the pigment ink 2′ in any state. For example, the resin may be dispersed or dissolved in the pigment ink 2′, preferably dispersed.

This improves the ejection stability of the pigment ink 2′ ejected by the ink jet technology, allowing more stable production of the recorded products 100.

When the resin is dispersed in the pigment ink 2′, the average particle size of the resin may be preferably 30 nm or more and 3 μm or less, more preferably 50 nm or more and 1 μm or less, and further more preferably 60 nm or more and 300 nm or less. This makes the above-described effects more pronounced.

In this specification, the average particle size refers to a volume-based average particle size. For example, a sample is added to methanol, dispersed in an ultrasonic disperser for 3 minutes, and the dispersion is put in a Coulter counter particle size distribution analyzer (Model TA-II available from Coulter Electronics, INS.) using a 50 μm aperture to determine the average particle size.

Examples of the resins contained in the pigment ink 2′ include polyurethane, polyester, styrene acrylic resin, acrylic resin, and polyvinyl chloride. One or more of these may be used in combination. Among them, polyurethane may be preferably employed. This makes the above-described effects more pronounced.

The glass transition temperature of the resin in the pigment ink 2′ is preferably −40° C. or more and 0° C. or less, more preferably −35° C. or more and −5° C. or less, and further more preferably −30° C. or more and −10° C. or less.

This allows the produced recorded products 100 to have better texture and higher washing fastness, for example.

It may be preferable that 0.2≤XR/XP≤1.8 be satisfied, it may be more preferable that 0.6≤XR/XP≤1.5 be satisfied, and it may further be preferable that 0.8≤XR/XP≤1.2 be satisfied, where XR (mass %) represents the resin content in the pigment ink 2′, and XP (mass %) represents the pigment content in the pigment ink 2′.

This readily allows the recording section 4 formed of the pigment ink 2′ to have a sufficient color density and thus improves the chromogenic properties of the receiving medium, and also improves the storage stability of the pigment ink 2′, the ejection stability of the ink jet technology, and the recoverability from clogging in the ink jet head. Furthermore, this allows the recorded products 100 to have better texture and the recording section 4 to have higher adhesion to the receiving medium 5.

### 1-1-2-5 Surfactant

The pigment ink 2′ may contain a surfactant.

The surfactant may be any kind of surfactant, such as an anionic surfactant, a cationic surfactant, and a nonionic surfactant.

When the pigment ink 2′ contains a surfactant, the pigment ink 2′ may contain the surfactant in an amount of preferably 0.02 mass % or more and 1.50 mass % or less, more preferably 0.05 mass % or more and 1.00 mass % or less, and further more preferably 0.10% or more and 0.70% or less.

### 1-1-2-6 Other Components

The pigment ink 2′ may contain components other than those described above. In the following description, such components may be referred to as “other components” in this section.

Examples of the other components include chelating agents, preservatives, antifungal agents, rust inhibitors, flame retardants, various dispersants, pH adjusters such as triethanolamine, dyes, antioxidants, UV absorbers, oxygen absorbers, dissolution aids, and penetrating agents.

Examples of the chelating agent include ethylenediamine tetraacetic acid. Examples of the preservatives and antifungal agents include sodium benzoate, sodium pentachlorophenol, sodium 2-pyridinthiol-1-oxide, sodium sorbate, sodium dehydroacetate, 1,2-dibenzoisothiazolin-3-one, and 4-chloro-3-methylphenol. Examples of the rust inhibitors include benzotriazole.

The preservatives and the antifungal agents may be composed of compounds having an isothiazoline ring structure in the molecule.

The pigment ink 2′ may contain other components in an amount of preferably 6.0 mass % or less, more preferably 5.0 mass % or less. The lower limit of the content of other components is 0 mass %.

### 1-1-2-7 Other Conditions

The viscosity of the pigment ink 2′ at 25° C. may be preferably 2 mPa·s or more and 10 mPa·s or less, more preferably 3 mPa·s or more and 8 mPa·s or less.

This reduces clogging of the nozzles of the ink jet head, for example, and improves the ejection stability of the pigment ink 2′. Furthermore, if the nozzles are clogged, the above configuration allows the nozzles to be more readily unclogged by nozzle capping.

The viscosity can be measured by using a vibrational viscometer, a rotational viscometer, a capillary viscometer, or a rolling-ball viscometer. For example, the viscosity is determined by using a vibration viscometer in accordance with JIS Z8809.

The pigment ink 2′ may have any surface tension at 25° C. However, the surface tension may be preferably 20 mN/m or more and 60 mN/m or less, more preferably 25 mN/m or more and 50 mN/m or less, and further more preferably 27 mN/m or more and 40 mN/m or less.

This reduces clogging of the nozzles of the ink jet head, for example, and improves the ejection stability of the pigment ink 2′. Furthermore, if the nozzles are clogged, the above configuration allows the nozzles to be more readily unclogged by nozzle capping.

The surface tension can be measured by the Wilhelmy method or the ring method. The surface tension can be measured using a surface tensiometer (such as DY-300, DY-500, and DY-700 available from Kyowa Interface Science Co., Ltd).

### 1-1-3 Ejection Using Ink Jet Technology

The pigment ink 2′ is ejected onto the transfer medium 1 having the release layer 12 by the ink jet technology to form the first layer 2. More specifically, the pigment ink 2′ is ejected to be in contact with the release layer 12 of the transfer medium 1.

Examples of the ink jet technology include a charge deflection method, a continuous method, and on-demand methods such as piezoelectric and Bubble Jet (registered trademark). In particular, piezoelectric, which ejects the ink from an ink jet head having a piezoelectric transducer, may be preferably employed.

This more effectively prevents unintentional denaturation of the components of the pigment ink 2′ in the ink jet head 50 and further improves the ejection stability of the ink jet technology.

Examples of the ink jet head 50 include a line head that records using a line method and a serial head that records using a serial method.

In the line method using a line head, for example, the recording apparatus has a fixed ink jet head having a width larger than the recording width of the transfer medium 1. The transfer medium 1 is moved in the sub-scanning direction (the traveling direction of the transfer medium 1) and ink drops are ejected from the nozzles of the ink jet head 50 in conjunction with this movement to form the first layer 2 on the transfer medium 1.

In the serial method using the serial head, for example, a carriage movable in the width direction of the transfer medium 1 has the ink jet head 50. The carriage is moved in the main scanning direction (in the width direction of the transfer medium 1), and ink droplets are ejected from the nozzles of the serial head, which is the ink jet head 50, in conjunction with this movement to form the first layer 2 on the transfer medium 1.

In this step, the first layer 2 is formed as the reversed image of the recording section 4 to be formed on the receiving medium 5.

In this step, multiple kinds of pigment inks 2′ may be used. For example, pigment inks 2′ of different shades, more specifically, a black ink, a cyan ink, a magenta ink, and a yellow ink may be used.

### 1-2 Second Layer Forming Step

In the second layer forming step, the ink jet head 50′ ejects the processing solution 3′ to form the second layer 3 on the first layer 2 formed on the transfer medium 1 (1b).

### 1-2-1 Processing Solution

The processing solution 3′, which is used to form the second layer 3, contains a resin and water.

### 1-2-1-1 Resin

The processing solution 3′ contains a resin.

This enables the recording section 4 to have higher adhesion to the receiving medium 5 and enables the recorded products 100 to have higher washing fastness.

Examples of the resin contained in the processing solution 3′ include polyester, polyurethane, polyvinyl chloride, styrene acrylic resin, and acrylic resin. One or more of these may be used in combination. One selected from the group consisting of polyester, polyurethane, and polyvinyl chloride may be preferably used, and polyurethane may be more preferably used.

This allows the recorded products 100 to have a higher level of texture and a higher level of washing fastness.

The resin may be contained in the processing solution 3′ in any form. For example, in the processing solution 3′, the resin may be dispersed or dissolved, preferably dispersed.

This improves the ejection stability of the pigment ink 2′ ejected by the ink jet technology, allowing more stable production of the recorded products 100. This also more effectively prevents unintentional remaining of the liquid components in the second layer 3 and the recording section 4.

When the resin is dispersed in the processing solution 3′, the average particle size of the resin may be preferably 30 nm or more and 3 μm or less, more preferably 50 nm or more and 1 μm or less, and further more preferably 60 nm or more and 300 nm or less. This makes the above-described effects more pronounced.

The resin contained in the processing solution 3′ may have a glass transition temperature of preferably −20° C. or more and 50° C. or less, more preferably −10° C. or more and 45° C. or less, and further more preferably 0° C. or more and 40° C. or

This allows the recorded products 100 to have a higher level of texture and a higher level of washing fastness.

The resin contained in the processing solution 3′ may have a melting point of preferably 80° C. or more and 140° C. or less, more preferably 85° C. or more and 130° C. or less, and further more preferably 90° C. or more and 120° C. or less.

This allows the recorded products 100 to have a higher level of texture and a higher level of washing fastness.

The processing solution 3′ may contain a resin in an amount of preferably 5.0 mass % or more and 20.0 mass % or less, more preferably 6.0 mass % or more and 17.0 mass % or less, and further more preferably 7.0 mass % or more and 15.0 mass % or

This allows the recorded products 100 to have a higher level of texture and a higher level of washing fastness.

### 1-2-1-2 Water

The processing solution 3′ contains water.

In the processing solution 3′, water functions, for example, as a dispersant that disperses the resin or a solvent that dissolves the resin.

The processing solution 3′ contains water in an amount of preferably 50.0 mass % or more and 85.0 mass % or less, more preferably 55.0 mass % or more and 80.0 mass % or less, and further more preferably 60.0 mass % or more and 75.0 mass % or less.

### 1-2-1-3 Organic Solvent

The processing solution 3′ may contain an organic solvent.

This enables proper adjustment of the viscosity and surface tension of the pigment ink 3′. In addition, this, for example, improves the moisture retention of the processing solution 3′, thus effectively prevents unintentional precipitation of solids from the processing solution 3′ due to drying in the ink jet head, for example. This can also improve the recoverability from clogging, resulting in improvement of the ejection stability of the processing solution 3′.

However, the processing solution 3′ may be preferably free from organic solvents having a boiling point of 280° C. or more.

This improves the drying characteristics of the second layer 3 formed by using the processing solution 3′, resulting in improvement of the removability of the stack including the first and second layers 2 and 3 from the transfer medium 1.

The organic solvent is preferably a water-soluble organic solvent.

As the water-soluble organic solvent, an organic solvent having a solubility of 10 g/100 g water or more at 25° C. is preferably used.

Examples of the organic solvent, especially the water-soluble organic solvent, in the pigment ink 2′ include polyol compounds, glycol ethers, and cyclic amide compounds. One or more of these may be used in combination.

Examples of the polyol compound include a polyol compound, preferably a diol compound, which has 2 to 6 carbon atoms in a molecule thereof and may have one ether bond in a molecule thereof. Specific examples thereof include 1,2-pentanediol, glycerin, ethylene glycol, diethylene glycol, triethylene glycol, polyethylene glycol, propylene glycol, dipropylene glycol, tripropylene glycol, polypropylene glycol, polyoxyethylene polyoxypropylene glycol, 1,2-hexanediol, 1,2-heptanediol, 1,3-propanediol, 1,2-butanediol, 1,3-butanediol, 1,4-butanediol, 2,3-butanediol, 2-methyl-3-phenoxy-1,2-propanediol, 3-(3-methylphenoxy)-1,2-propanediol, 3-hexyloxy-1,2-propanediol, 2-hydroxymethyl-2-phenoxymethyl-1,3-propanediol, 3-methyl-1,3-butanediol, 1,5-pentanediol, 1,6-hexanediol, 2-methyl-2,4-pentanediol, 3-methyl-1,5-pentanediol, and other glycols.

Examples of the glycol ether include monoalkyl ethers of glycol selected from the group consisting of ethylene glycol, diethylene glycol, triethylene glycol, polyethylene glycol, propylene glycol, dipropylene glycol, tripropylene glycol, polypropylene glycol, and polyoxyethylene polyoxypropylene glycol. Examples of the monoalkyl ethers include triethylene glycol mono methyl ether, triethylene glycol mono butyl ether, triethylene glycol monoethyl ether, and dipropylene glycol mono propyl ether.

Examples of the cyclic amide compounds include 2-pyrrolidone, N-methyl-2-pyrrolidone, N-hydroxyethyl-2-pyrrolidone, 1,3-dimethylimidazolidinone, 2-piperidone (8-valerolactam), and N-cyclohexyl-2-pyrrolidone.

In particular, the processing solution 3′ may preferably contain propylene glycol as an organic solvent.

This improves drying characteristics and accelerates curing of the resin on heating, resulting in improvement of fastness.

In particular, when the processing solution 3′ contains propylene glycol, the propylene glycol may account for preferably 50 mass % or more, more preferably 70 mass % or more, and further more preferably 80 mass % or more of the total organic solvent content in the processing solution 3′. This makes the above-described effects more pronounced.

The processing solution 3′ may contain the organic solvent in an amount of preferably 5.0 mass % or more and 35.0 mass % or less, more preferably 7.0 mass % or more and 30.0 mass % or less, and further more preferably 10.0 mass % or more and 25.0 mass % or less.

This enables more proper adjustment of the viscosity and surface tension of the processing solution 3′. In addition, this improves the moisture retention of the processing solution 3′, and thus effectively prevents unintentional precipitation of solids from the processing solution 3′ due to drying in the ink jet head, for example. This can also improve the recoverability from clogging, resulting in improvement of the ejection stability of the processing solution 3′.

### 1-2-1-4 Surfactant

The processing solution 3′ may contain a surfactant.

The surfactant may be any kind of surfactant, such as an anionic surfactant, a cationic surfactant, and a nonionic surfactant.

When the processing solution 3′ contains a surfactant, the pigment ink 2′ may contain the surfactant in an amount of preferably 0.02 mass % or more and 1.50 mass % or less, more preferably 0.05 mass % or more and 1.00 mass % or less, and further more preferably 0.10 mass % or more and 0.70 mass % or less.

### 1-2-1-5 Other Components

The processing solution 3′ may contain components other than those described above. In the following description, such components may be referred to as “other components” in this section.

Examples of the other components include chelating agents, preservatives, antifungal agents, rust inhibitors, flame retardants, various dispersants, pH adjusters such as triethanolamine, antioxidants, UV absorbers, oxygen absorbers, dissolution aids, and penetrating agents.

The processing solution 3′ may contain the other components in an amount of preferably 6.0 mass % or less, more preferably 5.0 mass % or less. The lower limit of the content of other components is 0 mass %.

### 1-2-1-6 Other Conditions

The processing solution 3′ may have a viscosity at 25° C. of preferably 2 mPa·s or more and 10 mPa·s or less, more preferably 3 mPa·s or more and 8 mPa·s or less.

This reduces clogging of the nozzles of the ink jet head, for example, resulting in improvement in the ejection stability of the processing solution 3′. Furthermore, if the nozzles are clogged, the above configuration allows the nozzles to be more readily unclogged by nozzle capping.

The processing solution 3′ may have any surface tension at 25° C. However, the surface tension may be preferably 20 mN/m or more and 60 mN/m or less, more preferably 25 mN/m or more and 50 mN/m or less, and further more preferably 27 mN/m or more and 40 mN/m or less.

This reduces clogging of the nozzles of the ink jet head, for example, resulting in improvement in the ejection stability of the processing solution 3′. Furthermore, if the nozzles are clogged, the above configuration allows the nozzles to be more readily unclogged by nozzle capping.

### 1-2-2 Ejection by Ink Jet Technology

The processing solution 3′ is ejected onto the transfer medium 1 having the first layer 2 by the ink jet technology to form the second layer 3.

Examples of the ink jet technology include a charge deflection method, a continuous method, and on-demand methods such as piezoelectric and Bubble Jet (registered trademark). In particular, piezoelectric, which ejects the ink from an ink jet head having a piezoelectric transducer, may be preferably employed.

This more effectively prevents unintentional denaturation of the components of the processing solution 3′ in the ink jet head 50 and further improves the ejection stability of the ink jet technology.

Examples of the ink jet head 50′ include a line head that records using a line method and a serial head that records using a serial method.

In this step, the second layer 3 is formed on the first layer 2, particularly, in the same pattern as the first layer 2.

The first layer 2 and the second layer 3 may be formed by different ink jet recording apparatuses, but preferably formed by the same ink jet recording apparatus.

The dryness of the first layer 2 when the processing solution 3′ is ejected in this step is only required to be 0% or more and 80% or less. However, the dryness of the first layer 2 may be preferably 10% or more and 75% or less, more preferably 20% or more and 70% or less, and further more preferably 35% or more and 65% or less.

This effectively prevents the final recorded product 100 from having unintentional remaining of the liquid components and allows the above-described effects of the present disclosure to be more pronounced.

In this step, the dryness of the first layer 2 when the processing solution 3′ is ejected can be suitably adjusted, for example, by adjusting the composition of the pigment ink 2′, the temperature, humidity, and pressure of the atmosphere that holds the transfer medium 1, and the time between the attachment of the pigment ink 2′ onto the transfer medium 1 and the attachment of the processing solution 3′.

The temperature of the atmosphere that holds the transfer medium 1 having the pigment ink 2′ depends on, for example, the composition of the pigment ink 2′. However, the temperature may be preferably 1° C. or more and 40° C. or less, more preferably 5° C. or more and 30° C. or less.

The humidity of the atmosphere that holds the transfer medium 1 having the pigment ink 2′ depends on, for example, the composition of the pigment ink 2′. However, the humidity may be preferably 10% RH or more and 95% RH or less, more preferably 20% RH or more and 90% RH or less.

The pressure of the atmosphere that holds the transfer medium 1 having the pigment ink 2′ depends on, for example, the composition of the pigment ink 2′. However, the pressure may be preferably 1 kPa or more and 150 kPa or less, more preferably 10 kPa or more and 110 kPa or less.

The time between the attachment of the pigment ink 2′ onto the transfer medium 1 and the attachment of the processing solution 3′ depends on the composition of the pigment ink 2′ but may be preferably 1 second or more and 60 seconds or less, more preferably 2 seconds or more and 30 seconds or less. In this step, multiple kinds of processing solution 3′ may be used.

### 1-3 Thermal Transfer Step

In the thermal transfer step, the surface of the transfer medium 1 that has the first and second layers 2 and 3 is heated, with the surface facing the absorbent receiving medium 5, to thermally transfer the first and second layers 2 and 3 to the receiving medium 5 (1c).

### 1-3-1 Receiving Medium

The receiving medium 5 may be any absorbent member. Examples of the absorbent member include various kinds of paper, porous metals, porous ceramics, porous glass, porous plastic, fabric, and leather. Among them, fabric and leather may be preferably employed.

This allows an image to be transferred to a finished product, which is a sewn fabric or leather, in any location, and provides good color development and abrasion resistance.

### 1-3-2 Heating Conditions

This step may employ any heating temperature. However, the temperature may be preferably 120° C. or more and 270° C. or less, more preferably 140° C. or more and 250° C. or less, and further more preferably 150° C. or more and 210° C. or less.

This can prevent the constituents of the first and second layers 2 and 3 from unintentionally remaining on the transfer medium 1 and can produce the recorded products 100 with higher productivity and less energy.

It may be preferable that 70≤Tp−Tg≤290 be satisfied, it is more preferable that 95≤Tp−Tg≤260 is satisfied, and it may be more preferable that 110≤Tp−Tg≤210 is satisfied, where Tg (° C.) represents the glass transition temperature of the resin contained in the processing solution 3′, and Tp (C) represents the heating temperature in the thermal transfer step.

This can prevent the constituents of the first and second layers 2 and 3 from unintentionally remaining on the transfer medium 1 and can produce the recorded products 100 with higher productivity and less energy.

This step may employ any heating duration. However, the heating duration may be preferably 5 seconds or more and 90 seconds or less, more preferably 15 seconds or more and 70 or less, and further more preferably 20 seconds or more and 60 seconds or less.

This can prevent the constituents of the first and second layers 2 and 3 from unintentionally remaining on the transfer medium 1 and can produce the recorded products 100 with higher productivity and less energy.

This step may be performed by any method that heats the surface of the transfer medium 1 having the first and second layers 2 and 3, with the surface facing the absorbent receiving medium 5. However, heat pressing may be preferably employed.

When this step is performed by heat pressing, the pressure applied to the stack including the transfer medium 1 and the receiving medium 5 may be preferably 0.1 N/cm² or more and 30 N/cm² or less, more preferably 0.6 N/cm² or more and 15 N/cm² or less, and more preferably 1.5 N/cm² or more and 5 N/cm² or less.

### 1-4 Recorded Product

The above steps produce a recorded product 100 (1D).

The recorded product 100 produced as described above has the recording section 4 including the first and second layers 2 and 3.

The recording section 4 preferably has at least a portion in the absorbent receiving medium 5.

The recording section 4 commonly includes at least a portion composed of a mixture of the first and second layers 2 and 3. In the configuration illustrated in the drawings, the entire recording section 4 is composed of a mixture of the constituents of the first and second layers 2 and 3.

### 1-5 Summary

As described above, the recording method according to the present disclosure includes: a first layer forming step of ejecting a pigment ink containing a pigment and water from an ink jet head onto a transfer medium having a release layer to form a first layer; a second layer forming step of ejecting a processing solution from the ink jet head onto the first layer to form a second layer; and a thermal transfer step of heating a surface of the transfer medium that has the first layer and the second layer, with the surface facing an absorbent receiving medium, to thermally transfer the first layer and the second layer onto the receiving medium, wherein the pigment ink contains a resin in an amount of 15.0 mass % or less, the processing solution contains a resin and water, and the first layer has a dryness of 0% or more and 80% or less when the processing solution is ejected. The recording method may include: a first layer forming step of ejecting a pigment ink that contains a pigment, a resin having a glass transition temperature of −40° C. or more and 0° C. or less, an organic solvent having a boiling point of 280° C. or more, and water from an ink jet head onto a transfer medium having a release layer to form a first layer; a second layer forming step of ejecting a processing solution from the ink jet head onto the first layer to form a second layer; and a thermal transfer step of heating a surface of the transfer medium that has the first layer and the second layer, with the surface facing an absorbent receiving medium formed of fabric or leather, to thermally transfer the first layer and the second layer onto the receiving medium, wherein the pigment ink contains the resin in an amount of 2.0 mass % or more and 15.0 mass % or less, the processing solution contains a resin having a glass transition temperature of −20° C. or more and 50° C. or less and a melting point of 80° C. or more and 140° C. or less and water and is free from organic solvents having a boiling point of 280° C. or more, the resin contained in the processing solution is at least one selected from the group consisting of polyester, polyurethane, and polyvinyl chloride, the processing solution contains the resin in an amount of 5.0 mass % or more and 20.0 mass % or less, and the first layer has a dryness of 0% or more and 80% or less when the processing solution is ejected.

This allows each of the above-described effects to work synergistically with each other, resulting in a particularly excellent effect.

### 2. Ink and Processing Solution Set

Next, the ink and processing solution set of the present disclosure will be described. The ink and processing solution set of the present disclosure includes the above-described pigment ink and processing solution.

More specifically, the ink and processing solution set of the present disclosure may preferably include a pigment ink that satisfies the conditions described in 1-1-2 and the processing solution described in 1-2-1.

The ink and processing solution set of the present disclosure is only required to include at least one kind of pigment ink and at least one kind of processing solution but may include multiple kinds of pigment ink or multiple kinds of processing solution. Furthermore, the ink and processing solution set of the present disclosure may also include other inks and processing solutions in addition to the pigment ink and the processing solution that satisfy the above conditions.

The embodiment according to the present disclosure was described above. However, the present disclosure should not be limited to the above-described embodiment.

For example, in the above description, an absorbent member is used as the receiving medium, but a non-absorbent member, such as a metal or plastic member that is non-absorbent, may also be used as the receiving medium.

In the above-described embodiment, after formation of the first layer having the desired pattern on the transfer medium, the second layer having the desired pattern is formed by ejecting the processing solution, and then the thermal transfer step is performed. However, in the present disclosure, multiple steps may be performed simultaneously. More specifically, for example, the pigment ink and the processing solution may be ejected simultaneously at different portions of the same transfer medium.

### EXAMPLES

Next, specific examples of the present disclosure will be described.

### 3. Preparation of Pigment Ink

### Preparation A1

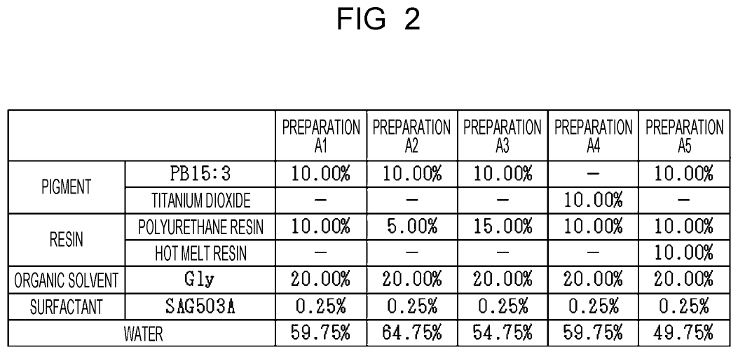

A pigment ink having the composition indicated in FIG. 2 was produced by mixing the components in a predetermined ratio.

### Preparations A2 to A5

Pigment inks were prepared in the same way as the pigment ink of Preparation A1 except that the kinds of components that form the pigment inks and the ratios of the components were changed as indicated in FIG. 2.

FIG. 2 collectively indicates the compositions of the pigment inks of Preparations A1 to A5. The numerical values of the components followed by “%” in FIG. 2 indicate the contents by mass percent. In FIG. 2, “PB15:3” is C.I. Pigment Blue 15:3, “polyurethane resin” is polyurethane resin having a glass transition temperature of −20° C. (TAKELAC W6110 solid content available from Mitsui Chemicals, Inc.), “hot melt resin” is hot melt resin (KT08701 solid content available from UNITIKA LTD.), “Gly” is glycerin, which is a water-soluble organic solvent, and “SAG503A” is SILFACE SAG503A (available from Nissin Chemical Industries, Ltd.) as a surfactant. The pigment inks of Preparations A1 to A5 each include the resin having the average particle size in a range between 60 nm and 300 nm, inclusive. The pigment inks of Preparations A1 to A5 each have the surface tension at 25° C. in a range between 30 mN/m and 40 mN/m, inclusive, and the viscosity at 25° C. in a range between 3 mPa·s and 8 mPa·s, inclusive. The surface tension was measured by the Wilhelmy method using a surface tensiometer (DY-300 available from Kyowa Interface Science Co., Ltd), and the viscosity was measured in accordance with JIS Z8809 using a torsional oscillation-type viscometer (VM-100 available from SEKONIC CORPORATION).

### 4. Preparation of Processing Solution

### Preparation B1

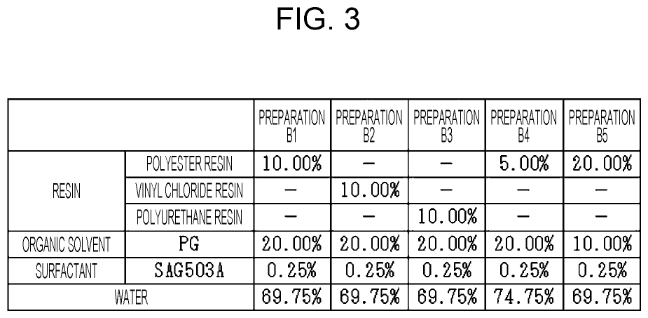

A processing solution having the composition indicated in FIG. 3 was produced by mixing the components in a predetermined ratio.

### Preparations B2 to B5

Processing solutions were prepared in the same way as the processing solution of Preparation B1 except that the kinds of components and the ratios of the components were changed as indicated in FIG. 3.

FIG. 3 collectively indicates the compositions of the processing solutions of Preparations B1 to B5. The numerical values of the components followed by “%” in FIG. 3 indicate the contents by mass percent. In FIG. 3, “polyester resin” is polyester resin (KT9204 solid content available from UNITIKA LTD.), “vinyl chloride resin” is vinyl chloride resin (VINYBLAN 715S solid content available from Mitsui Chemicals, Inc.), “polyurethane resin” is polyurethane resin (TAKELAC W6061 solid content available from Mitsui Chemicals, Inc.), “PG” is propylene glycol, which is a water-soluble organic solvent, and “SAG503A” is SILFACE SAG503A (available from Nissin Chemical Industry Co., Ltd.) as a surfactant. The processing solutions of Preparations B1 to B5 each include the resin having the average particle size in a range between 60 nm and 300 nm, inclusive. The processing solutions in Preparations B1 to B5 each have the surface tension at 25° C. in a range between 30 mN/m and 40 mN/m, inclusive, and the viscosity at 25° C. in a range between 3 mPa's and 8 mPa·s, inclusive. The surface tension was measured by the Wilhelmy method using a surface tensiometer (DY-300 available from Kyowa Interface Science Co., Ltd), and the viscosity was measured in accordance with JIS Z8809 using a torsional oscillation-type viscometer (VM-100 available from SEKONIC CORPORATION).

### 5. Production of Recorded Product

### Example 1

First, a transfer medium (printed film for DTF available from inkmania) including a base composed of polyethylene terephthalate and a release layer composed of a release agent on the base was provided.

Next, the pigment ink of Preparation A1 and the processing solution of Preparation B1 were loaded in an ink jet recording apparatus (SC-F2150 available from Seiko Epson), and the pigment ink was ejected from the ink jet head onto the surface of the transfer medium that has the release layer to form the first layer having a predetermined pattern.

Next, the processing solution was ejected from the ink jet head onto the first layer to form a second layer having the same pattern as the first layer. The dryness of the first layer when the processing solution is ejected was 50%.

Next, the surface of the transfer medium that has the first and second layers was subjected to heat treatment at 200° C. for 40 seconds with the surface facing a cotton broadcloth (#4000), which is the absorbent receiving medium available from Nisshinbo Inc., to thermally transfer the first and second layers to the receiving medium. The transfer medium was then removed, and thus the recorded product was produced.

### Examples 2 to 19

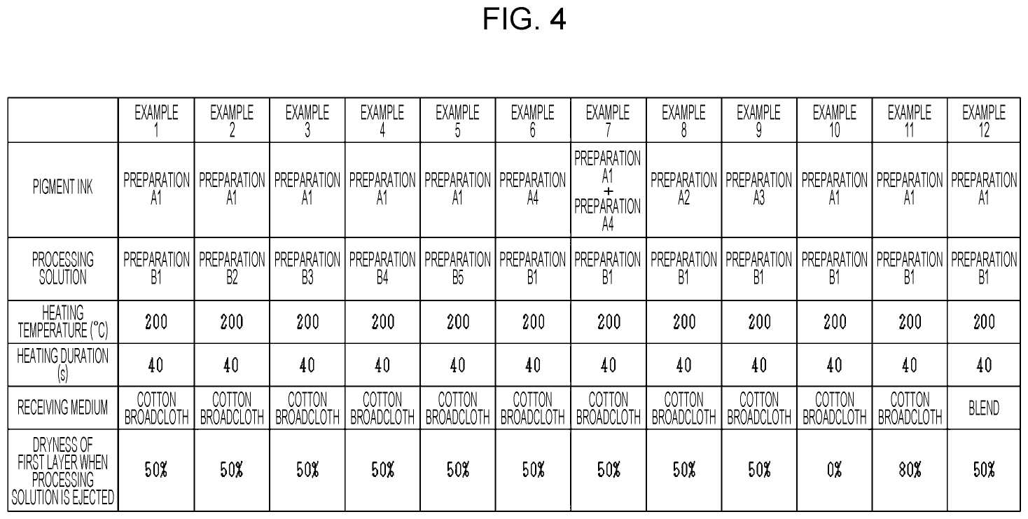

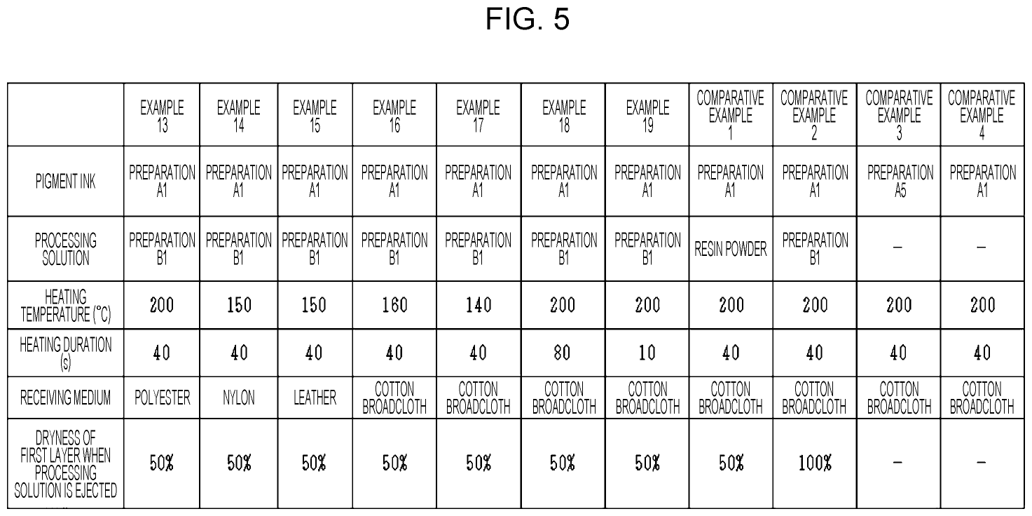

Recorded products were each produced in the same way as the recorded product of Example 1 except that the pigment ink, the kind of treatment solution, the heating conditions in the thermal transfer step, the kind of receiving medium, and the dryness of the first layer when the processing solution is ejected were changed as indicated in FIGS. 4 and 5. In Example 7, the pigment ink of Preparation A1 was ejected from the ink jet head to form a predetermined pattern, and then the pigment ink of Preparation A4 was ejected from the ink jet head onto the pattern formed of the pigment ink of Preparation A1, and thus the pattern of the first layer was produced. In other words, in Example 7, the first layer was a stack including a layer formed of the pigment ink of Preparation A1 and a layer formed of the pigment ink of Preparation A4.

### Comparative Example 1

A recorded product was produced in the same way as the recorded product of Example 1 except that Hot Melt Powder PU (polyurethane), which is a heat-melting powder available from inkmania, was sprinkled, as a resin powder, by using a cascade shaker (available from EUROPORT. Co., Ltd.), instead that the processing solution is applied onto the transfer medium having the first layer, and then the excessive resin powder was shaken off, and the thermal transfer to the receiving medium was performed as above.

### Comparative Example 2

A recorded product was produced in the same way as that of Example 1 except that the dryness of the first layer when the processing solution forming the second layer is ejected was changed to 100%.

### Comparative Example 3

A recorded product was produced in the same way as that in Example 1 except that the pigment ink of Preparation A5 was used to form the first layer and the step of forming the second layer was omitted.

### Comparative Example 4

A recorded product was produced in the same way as that of Example 1 except that the step of forming the second layer was omitted.

FIGS. 4 and 5 collectively indicate the conditions for the production of the recorded products of Examples and Comparative Examples, i.e., the conditions of the recording method. In FIGS. 4 and 5, “cotton broadcloth” refers to cotton broadcloth (#4000), which is a receiving medium available from Nisshinbo Inc., “blend” refers to TC4520 (blend fabric of 35 mass % cotton and 65 mass % polyester fiber available from TOYOSHIMA & CO., LTD), which is a receiving medium, “polyester” refers to Tropical (polyester fabric available from Toray Industries, Inc.), which is a receiving medium, “nylon” refers to PAREL Taffeta N2188 (nylon fabric available from Toray Industries, Inc.,), which is a receiving medium, and “leather” refers to natural leather cowhide (available from Daiki Hikaku K. K.), which is a receiving medium.

### 6. Evaluation

### 6-1 Texture

The recorded products of Examples and Comparative Examples were evaluated for texture as follows.

Specifically, the recorded products were each sensory evaluated for texture by specific blindfolded evaluators according to the following criteria.

The evaluation result “A” means the highest level of texture, followed in order by “B” and “C”. The evaluation results A and B indicate that the effects of this application were achieved.
A: Soft and non-coarse
B: Slightly hard and slightly coarse
C: Very coarse

### 6-2 Dry Rubbing Fastness

The recorded products of Examples and Comparative Examples were evaluated for dry rubbing fastness as follows.

Specifically, the recorded products were each left at 25° C. for one hour after production, and the recorded surface of the recorded product was rubbed 20 times with a cotton cloth under a load of 200 g by using the AB-301 Color Fastness Rubbing Tester (available from TESTER SANGYO CO., LTD.). The recorded products were visually checked for chipping of the recording section and ink transfer to the cotton cloth, and the abrasion resistance was evaluated according to the following criteria. The less the color migration and chipping, the higher the abrasion resistance. The higher the abrasion resistance, the higher the fastness. Evaluations A and B were considered sufficient levels.
A: No recognizable color migration and chipping
B: Slightly recognizable color migration and chipping
C: Clearly recognizable color migration and chipping

### 6-3 Wet Rubbing Fastness

The recorded products of Examples and Comparative Examples were evaluated for wet rubbing fastness as follows.

Specifically, the above-described recorded products were each left at 25° C. for one hour after production, and the recorded surface of the object was rubbed 20 times under a load of 200 g, with a cotton cloth soaked and moistened in pure water, by using the AB-301 Color Fastness Rubbing Tester (available from TESTER SANGYO CO., LTD.). The recorded products were visually checked for chipping of the recording section and ink transfer to the cotton cloth, and the abrasion resistance was evaluated according to the following criteria. The less the color migration and chipping, the higher the abrasion resistance. The higher the abrasion resistance, the higher the fastness. Evaluations A and B were considered sufficient levels.
A: No recognizable color migration and chipping;
B: Slightly recognizable color migration and chipping; and
C: Clearly recognizable color migration and chipping.

### 6-4 Washing Fastness

The recorded products of Examples and Comparative Examples were evaluated for washing fastness as follows.

Specifically, the washing fastness test was carried out in accordance with ISO 105 C10 (B2), and the washing fastness was evaluated according to the following criteria. Evaluations A and B were considered sufficient levels.
A: Washing fastness level of 3 or higher
B: Washing fastness level of 2 or higher and lower than 3
C: Washing fastness level of lower than 2

### 6-5 Removability

The above examples and comparative examples were each observed for the state of the transfer medium after transfer of the recording section to the receiving medium and evaluated for removability according to the following criteria. Evaluations A and B were considered sufficient levels.
A: 100% transfer of the image area printed on the transfer medium
B: 80% or more and less than 100% transfer of the image area printed on the transfer medium
C: Less than 80% transfer of the image area printed on the transfer medium

### 6-6 Clogging

The pigment inks and the processing solutions used to produce the recorded products of Examples and Comparative Examples were filled into ink jet printers (product name PX-G930 available from Seiko Epson Corporation) and left for one month with the cap open. Cleaning was then performed three times, and the number of misfiring nozzles were determined and evaluated according to the following criteria. Evaluations A and B were considered sufficient levels.
A: No misfiring nozzles
B: One or more and five or less misfiring nozzles
C: Six or more and twenty or less misfiring nozzles
D: Twenty-one or more misfiring nozzles

### 6-7 Apparatus Size

The footprints of the apparatuses used to produce the recorded products of Examples and Comparative Examples were compared. Specifically, the sum of the footprint of the ink jet recording apparatus used to form the first and second layers in Comparative Example 1 and the footprint of the Cascade Shaker (available from EUROPORT. Co., Ltd.) were calculated, and the ratio of the footprint of the apparatus used to form the first and second layers in each of Examples and Comparative Examples to the sum were determined and evaluated according to the following criteria.
A: Less than 50% the apparatus footprint of Comparative Example 1
B: 50% or more and less than 100% the apparatus footprint of Comparative Example 1
C: 100% or more the apparatus footprint of Comparative Example 1

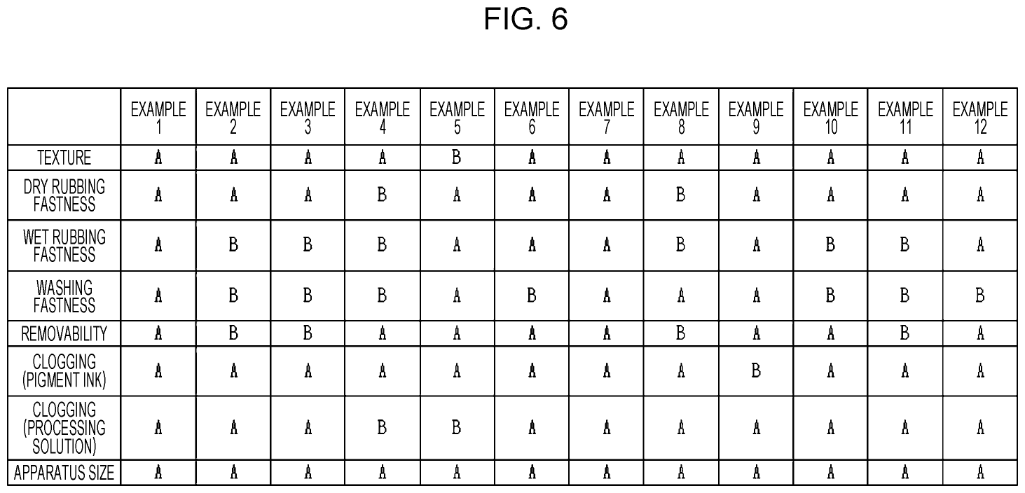

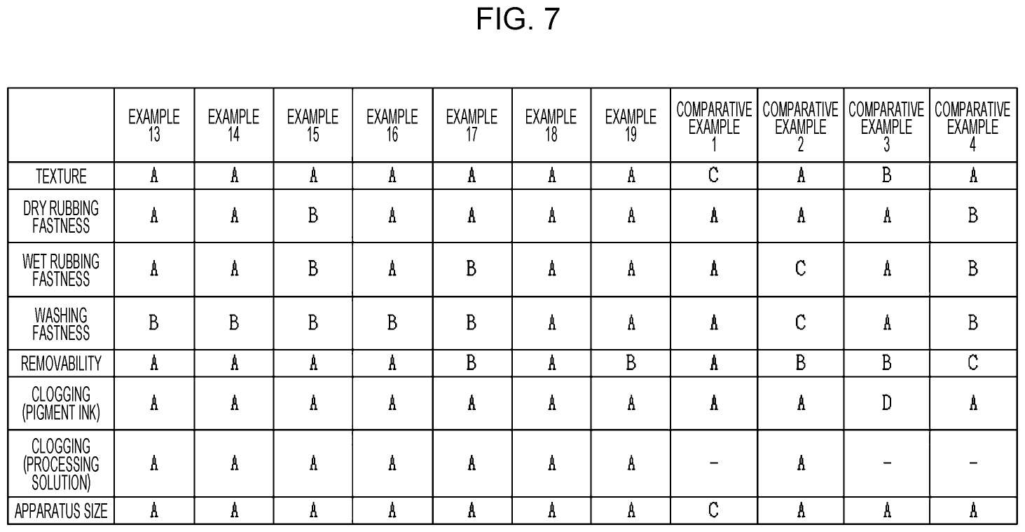

FIGS. 6 and 7 collectively indicate the evaluation results. As is clear from FIGS. 6 and 7, Examples of the present disclosure showed excellent results. In contrast, Comparative Examples showed unsatisfactory results.

What is claimed is:

1. A recording method comprising:
a first layer forming step of ejecting a pigment ink containing a pigment and water from an ink jet head onto a transfer medium having a release layer to form a first layer;
a second layer forming step of ejecting a processing solution from the ink jet head onto the first layer to form a second layer; and
a thermal transfer step of heating a surface of the transfer medium that has the first layer and the second layer, with the surface facing an absorbent receiving medium, to thermally transfer the first layer and the second layer onto the receiving medium, wherein
the pigment ink contains a resin in an amount of 15.0 mass % or less,
the processing solution contains a resin and water, and
the first layer has a dryness of 0% or more and 80% or less when the processing solution is ejected.

2. The recording method according to claim 1, wherein the resin contained in the processing solution is at least one selected from the group consisting of polyester, polyurethane, and polyvinyl chloride.

3. The recording method according to claim 1, wherein the resin contained in the processing solution has a glass transition temperature of −20° C. or more and 50° C. or less.

4. The recording method according to claim 1, wherein the resin contained in the processing solution has a melting point of 80° C. or more and 140° C. or less.

5. The recording method according to claim 1, wherein the processing solution contains the resin in an amount of 5.0 mass % or more and 20.0 mass % or less.

6. The recording method according to claim 1, wherein the processing solution is free from organic solvents having a boiling point of 280° C. or more.

7. The recording method according to claim 1, wherein the pigment ink contains a resin having a glass transition temperature of −40° C. or more and 0° C. or less.

8. The recording method according to claim 1, wherein the pigment ink contains an organic solvent having a boiling point of 280° C. or more.

9. The recording method according to claim 1, wherein the receiving medium is fabric or leather.

10. A recording method comprising:
a first layer forming step of ejecting a pigment ink that contains a pigment, a resin having a glass transition temperature of −40° C. or more and 0° C. or less, an organic solvent having a boiling point of 280° C. or more, and water from an ink jet head onto a transfer medium having a release layer to form a first layer;
a second layer forming step of ejecting a processing solution from the ink jet head overo the first layer to form a second layer; and
a thermal transfer step of heating a surface of the transfer medium that has the first layer and the second layer, with the surface facing an absorbent receiving medium formed of fabric or leather, to thermally transfer the first layer and the second layer onto the receiving medium, wherein
the pigment ink contains the resin in an amount of 2.0 mass % or more and 15.0 mass % or less,
the processing solution contains a resin having a glass transition temperature of −20° C. or more and 50° C. or less and a melting point of 80° C. or more and 140° C. or less and water and is free from organic solvents having a boiling point of 280° C. or more,
the resin contained in the processing solution is at least one selected from the group consisting of polyester, polyurethane, and polyvinyl chloride,
the processing solution contains the resin in an amount of 5.0 mass % or more and 20.0 mass % or less, and
the first layer has a dryness of 0% or more and 80% or less when the processing solution is ejected.
